(19) United States
(12) Patent Application Publication
(10) Pub. No.: US 2023/0286605 A1
(43) Pub. Date: Sep. 14, 2023

(54) SPACER

(71) Applicant: GIVI S.P.A., Flero ( Brescia) (IT)

(72) Inventor: Giuseppe VISENZI, Flero ( Brescia) (IT)

(21) Appl. No.: 18/018,279

(22) PCT Filed: Aug. 26, 2021
(86) PCT No.: PCT/IB2021/057823

§ 371 Date: Jan. 27, 2023

(30) Foreign Application Priority Data
Sep. 18, 2020 (IT) 102020000022063

(51) Int. Cl. B62J 9/24; B62J 9/27

(52) U.S. Cl. CPC B62J 9/24; B62J 9/27; B62J 9/23

(57) ABSTRACT

A spacer for fastening a side bag to a side of a motorcycle is provided. The spacer has a spacer rod and a fastening plate configured to be anchored to a side of a motorcycle frame to fasten the spacer rod to the motorcycle in a removable manner. The spacer rod has an anchoring pin that fits into a pin seat of the fastening plate. The fastening plate has a pin locking mechanism operatively connected to the pin seat and having retention elements radially movable with respect to a pin axis between a retracted pin releasing position and an advanced pin locking position.

The present invention relates to the field of accessories for motorcycles and in particular it relates to a spacer for fastening a side bag to a side of a motorcycle.

Spacers of this type are already known. According to the preamble of claim 1, a spacer usually comprises a spacer rod, for example in the form of a tube, which, in a position mounted to the motorcycle, holds the side bag at a predefined distance with respect to the motorcycle. The spacer rod is configured to be removably fastened, at one end thereof, to a fastening plate suitable to be anchored to a side of the motorcycle frame.

In use, the anchoring plate is permanently fastened to the motorcycle frame; when the motorcyclist wants to carry a side bag, he/she mounts the spacer rod to the anchoring plate. In this way, the spacer rod keeps the bag suitably detached from the vehicle.

The object of the present invention is to propose a spacer of the aforementioned type, which is particularly stable and safe in use and which at the same time allows easy and quick application and removal of the spacer rod to and from the anchoring plate.

Such an object is achieved with a spacer according to claim 1. The dependent claims describe preferred or advantageous embodiments of the spacer.

The features and the advantages of the spacer according to the invention shall be made readily apparent from the following description of preferred embodiment examples thereof, provided purely by way of a non-limiting example, with reference to the accompanying figures, wherein:

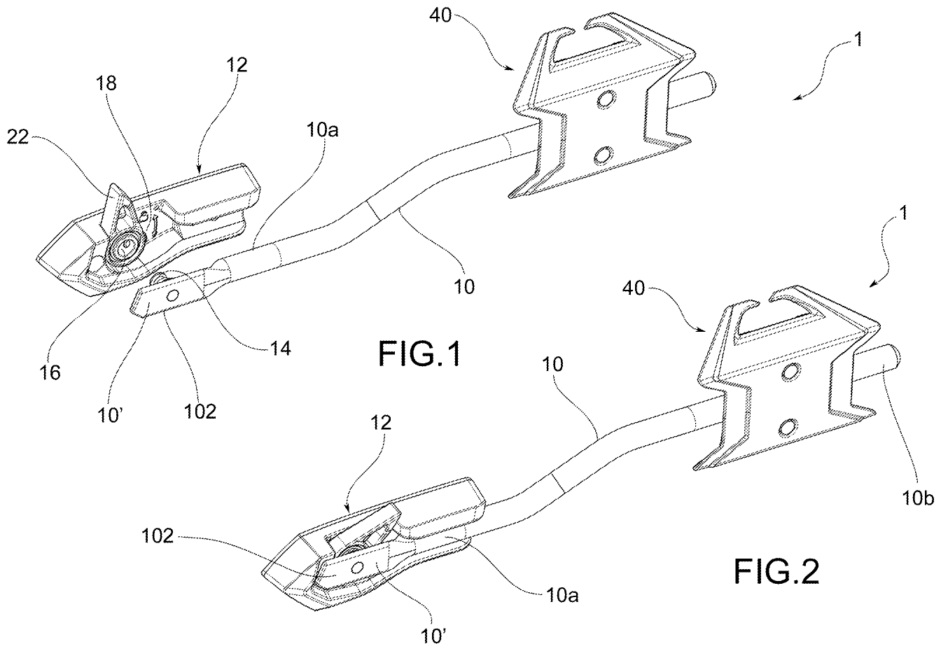

FIG. 1 is a perspective view of the spacer according to the invention, with the spacer rod separated from the fastening plate to the motorcycle frame;

FIG. 2 is a perspective view of the spacer according to the invention, with the spacer rod connected to the fastening plate;

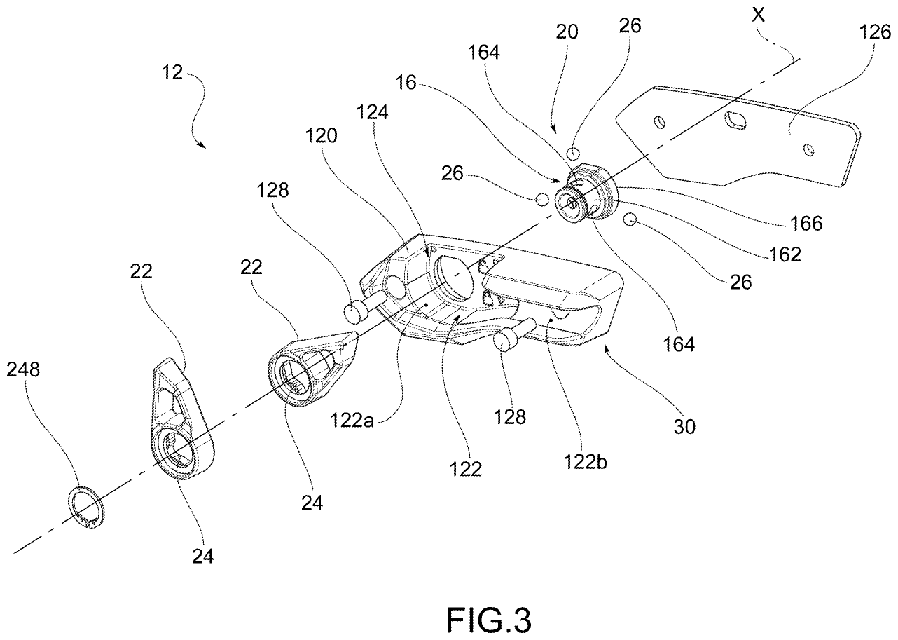

FIG. 3 is an exploded perspective view of the fastening plate only;

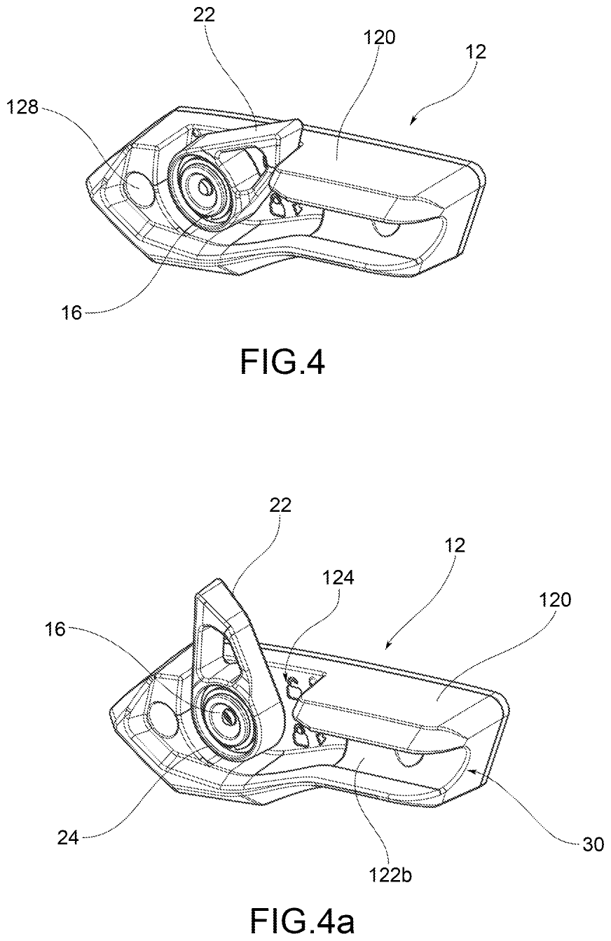

FIGS. 4 and 4a are two perspective views of the fastening plate assembled and in the configuration of locking and release of the spacer rod, respectively;

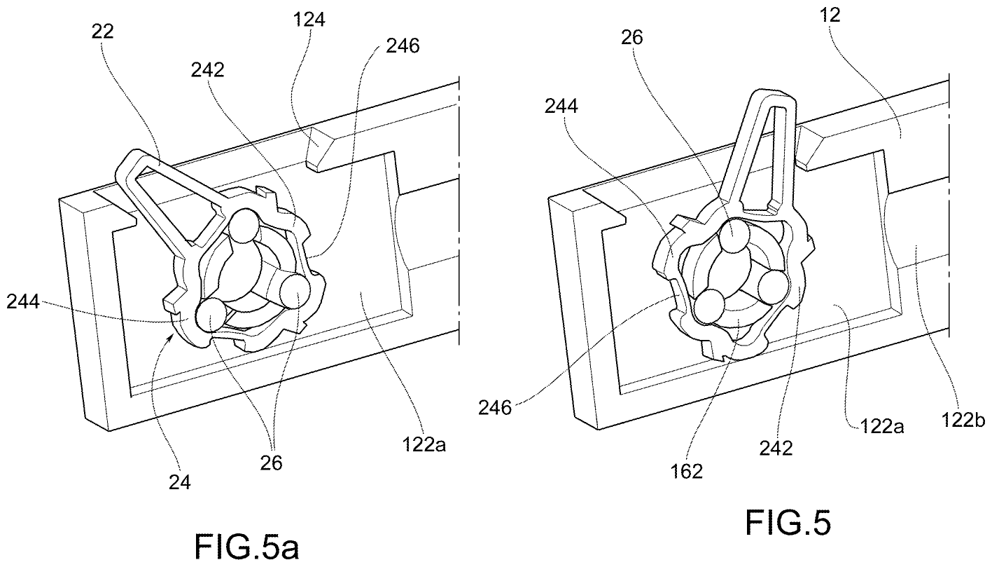

FIGS. 5 and 5a are two axially sectional perspective views of the fastening plate corresponding to the elements of the rod locking mechanism, in the locking and release positions, respectively;

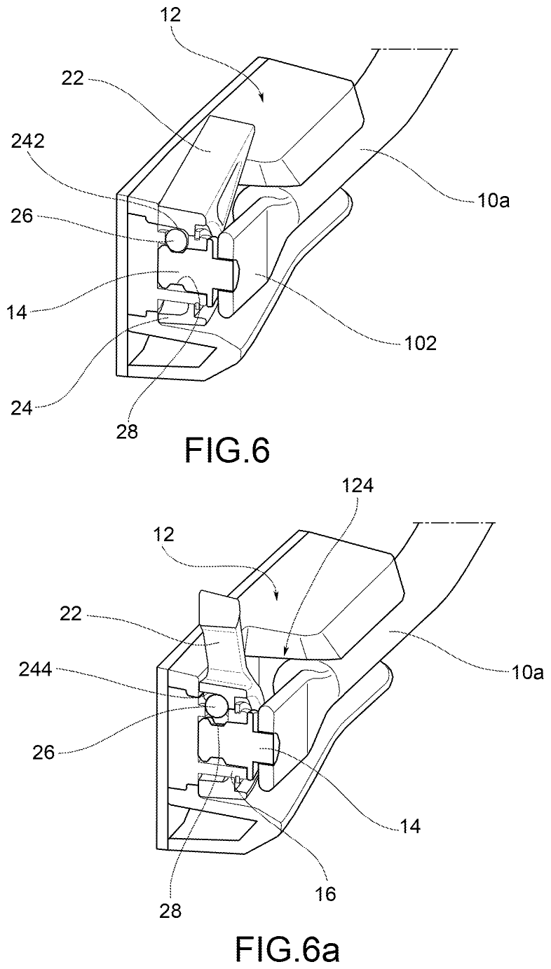

FIGS. 6 and 6a are two cross-sectional perspective views of the spacer, at the anchoring pin, in the locking and release positions, respectively;

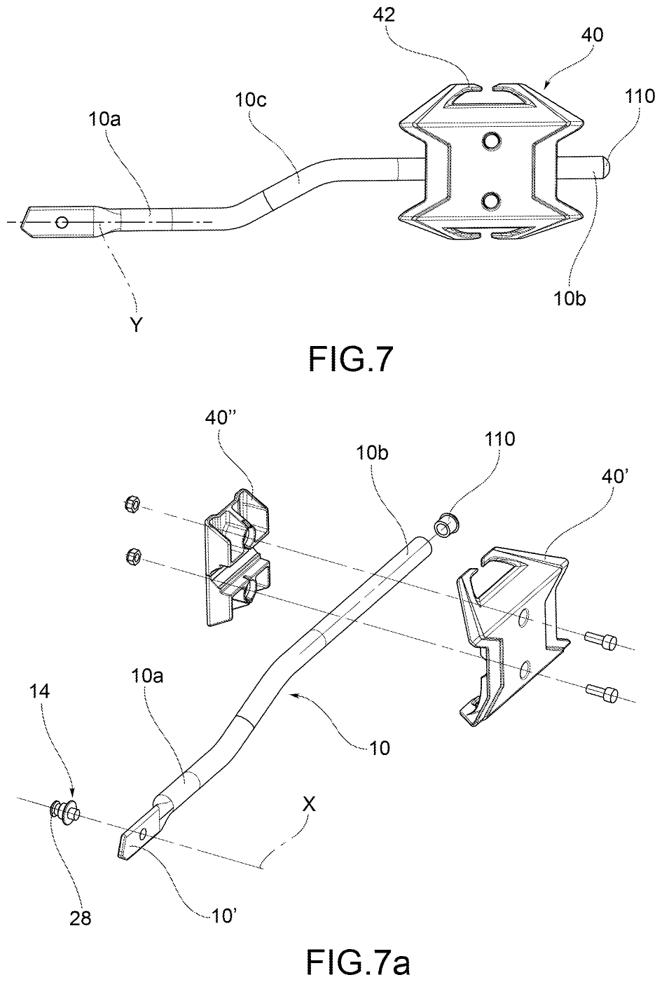

FIGS. 7 and 7a are a front view and an exploded perspective view, respectively, of the spacer rod only;

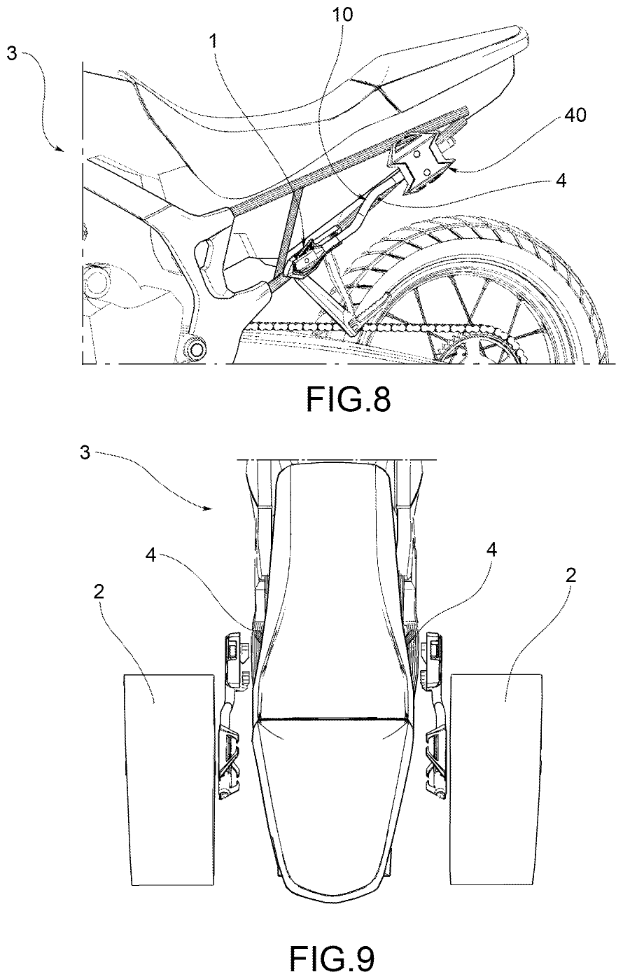

FIG. 8 is a perspective view of a motorcycle provided with a spacer according to the invention; and

FIG. 9 is a top plan view of a rear part of the motorcycle, provided with two spacers for two respective side bags.

In said drawings, reference numeral 1 indicates as a whole a spacer for fastening a side bag 2 to a side of a motorcycle 3.

In a general embodiment, the spacer 1 comprises a spacer rod 10 which, in a position mounted to the motorcycle, holds the side bag 2 at a predefined distance with respect to the motorcycle, and a fastening plate 12 suitable to be anchored to a side of the frame 4 of the motorcycle 3 to fasten the spacer rod 10 to the motorcycle 3 in a removable manner.

The spacer rod 10 is provided, at a proximal end 10′ thereof, with an anchoring pin 14 which extends orthogonally to an end portion 10a of the spacer rod 10.

In the continuation of the description, the term “proximal” referred to the spacer rod 10 indicates the end or the portion suitable to be connected to, or in any case facing towards, the fastening plate 12. Considering the spacer 1 mounted to the motorcycle, as in FIGS. 8 and 9, the proximal end or portion of the spacer rod can also be defined as front end or portion, as it faces the front of the motorcycle 3.

For example, the fastening plate 12 is suitable to be anchored on the part of the frame 4 which supports the passenger footrests 5.

The fastening plate 12 forms a pin seat 16 suitable to receive the anchoring pin 14 with shape coupling.

For example, the anchoring pin 14 and the pin seat 16 have a substantially cylindrical shape, or in any case comprise a substantially cylindrical portion.

The anchoring pin 14 extends about a pin axis X, which therefore coincides with the axis of the pin seat 16 when the anchoring pin 14 is accommodated in the pin seat 16.

Y indicating a proximal rod axis along which at least the proximal portion 10a of the spacer rod 10 extends, the pin axis X is substantially orthogonal to the proximal rod axis Y.

The fastening plate 12 is provided with a pin locking mechanism 18 operatively connected to the pin seat 16.

The pin locking mechanism 18 comprises retention means 20 radially movable with respect to the pin axis X between a retracted pin releasing position and an advanced pin locking position.

The pin locking mechanism 18 further comprises a control lever 22 operable by a user to move the retention means 20 from the retracted position to the advanced position, and vice versa.

In one embodiment, the locking mechanism 18 comprises an annular element 24 integral with the control lever 22.

The annular element 24 is positioned about the retention means 20. The annular element 24 has a cam profile configured to be rotatable, by means of the control lever 22, between a pin locking position, in which it radially acts on the retention means 20 so as to bring and retain them in an advanced pin locking position, and a pin releasing position, in which it allows the radial retraction of the retention means 20 to the retracted pin releasing position.

In one embodiment, the retention means 20 comprise at least a pair of balls 26, for example three equally spaced balls.

An annular groove 28 suitable to be engaged by the balls 26 is obtained in the anchoring pin 14. When the balls 26 engage the annular groove 28, the anchoring pin 14 is stably held in the pin seat 16.

In one embodiment, the pin seat 16 is delimited by a side wall 162 in which radial through openings 164 are obtained. In each of such radial through openings 164 a respective ball 26 is partially accommodated. The radial through openings 164 are dimensioned in such a way that the respective balls 26 can translate radially between the retracted position and the advanced position.

Each ball is therefore held between the respective radial through opening 164 and the annular element 24.

In one embodiment, the annular element 24 forms, for each ball 26, a first concave portion 242 and a second concave portion 244. The concave portions 242, 244 are obtained and distributed along the circular crown of the annular element 24. The first concave portion 242 has a lower, or less pronounced concavity, than the second concave portion 244, which has a more pronounced concavity. The first concave portion 242 forces the respective ball into the advanced pin locking position. The second concave portion 244 allows the respective ball to assume the retracted pin releasing position.

However, the two concave portions 242, 244 surround the spherical surface of the respective ball 26 opposite the radial through opening 164, so as to ensure the retention of the ball inside the locking mechanism, between the side wall of the pin seat 16 and the annular element 24.

In one embodiment, the two concave portions 242, 244 of each ball 26 are circumferentially separated from each other by a collapsible intermediate portion 246, suitable to ensure the semi-stable position of the annular element 24.

However, the two concave portions 242, 244 of each ball 26 are sufficiently close to each other so as to limit the rotation of the annular element 24, and therefore the stroke of the control lever 22, necessary to switch the locking mechanism from the pin locking position to the pin releasing position, and vice versa.

In one embodiment, moreover, the fastening plate 12 comprises a guide portion 30 suitable to receive a proximal portion 10a of the spacer rod 10 with shape coupling, so as to prevent a rotation of the spacer rod about the pin axis X.

For example, the fastening plate 12 has a plate body 120 which forms a plate cavity 122 open on the opposite side with respect to the frame 4 of the motorcycle 3. A front portion 122a of the plate cavity 122 extends about the pin seat 16 so as to accommodate the annular element 24. The plate body 120 also forms a window 124, that is a gap, through which the control lever 22 protrudes and can rotate.

A rear portion 122b of the plate cavity 122 has an elongated shape and is substantially complementary to the proximal portion 10a of the spacer rod 10.

In an embodiment illustrated in FIG. 3, the fastening plate 12 comprises a fastening sheet 126 suitable to be fastened to the frame 4 of the motorcycle 3.

The plate body 120 is fastened, for example by means of screws 128, to the fastening sheet 126.

In one embodiment, the pin seat 16 consists of a hollow insert provided with a connection head 166 fastened to the fastening plate 126 or to the plate body 120.

In one embodiment variant, the pin seat 16 is formed integrally with the plate body 120.

In one embodiment, the annular element 24 and the control lever 22 are made in one piece of plastic material.

The annular element 24 can be held axially about the pin seat 16 by means of a metal ring 248, for example a seeger.

Returning now to the spacer rod 10, in one embodiment the anchoring pin 14 is fastened to a flattened end 102 of the proximal portion 10a.

In one embodiment, the anchoring pin 14 is free to rotate about the pin axis X. In this way, it is possible for the user to insert and also lock the coupling pin in the pin seat without the spacer rod already in the correct position of use. In fact, by virtue of the free rotation of the coupling pin, the rod can be subsequently rotated so as to insert it into the guide portion of the fastening plate. The guide portion prevents the rod from rotating about the pin axis.

In one embodiment, the spacer rod 10 has a distal portion 10b parallel but not coaxial to the proximal portion 10a. The two proximal and distal portions can be connected to each other by an inclined intermediate portion 10c.

The spacer rod 10 can be made with a tubular element. The distal end 108 thereof can be closed by a plug 110.

In one embodiment, the distal portion 10b of the spacer rod 10 supports a bag connecting plate 40, comprising bag anchoring means 42.

The bag connecting plate 40 can be made, for example, in two parts 40′, 40″ clamped in a vice on the distal portion 104.

For example, the bag anchoring means 42 comprise belt anchoring areas and/or magnetic coupling means.

The bag connecting plate 40 can thus stabilize the support of the bottom of the bag. In the case of magnetic coupling, a magnet can be inserted in the bag connecting plate 40, so as to attract a corresponding magnetic or ferromagnetic element incorporated in the side bag 2.

It is evident that the spacer described above allows the intended objects to be achieved.

The spacer rod 10, in fact, in use is firmly and without clearance fastened to the fastening plate 12, by virtue of the locking mechanism.

The rod engagement/disengagement operations are extremely simple, fast and safe. The user can easily operate the control lever and, independently and not necessarily at the same time, insert or remove the anchoring pin in or from the pin seat.

By virtue of the axial symmetry of the locking mechanism, the anchoring pin can be inserted in any angular orientation in the pin seat. Furthermore, the presence of the guide portion of the fastening plate facilitates the coupling between the rod and the fastening plate.

The fastening plate has a compact and appealing structure.

A person skilled in the art may make several changes, adjustments, adaptations and replacements of elements with other functionally equivalent ones to the embodiments of the spacer according to the invention in order to meet incidental needs, without departing from the scope of the following claims. Each of the features described as belonging to a possible embodiment may be obtained independently of the other embodiments described.

1. A spacer for fastening a side bag to a side of a motorcycle, comprising:
a spacer rod which, in a position mounted to the motorcycle, holds the side bag at a predetermined distance with respect to the motorcycle, and
a fastening plate configured to be anchored to a side of a motorcycle frame to fasten the spacer rod to the motorcycle in a removable manner, wherein:
the spacer rod is provided, at a proximal end thereof, with an anchoring pin which that extends orthogonally to a proximal portion of the spacer rod;
the fastening plate forms a pin seat configured to receive the anchoring pin with shape coupling;
the fastening plate is provided with a pin locking mechanism operatively connected to the pin seat and comprising retention means radially movable with respect to a pin axis between a retracted pin releasing position and an advanced pin locking position, and a control lever operable by a user to move the retention means from the retracted pin releasing position to the advanced pin locking position, and vice versa.

2. The spacer of claim 1, wherein the pin locking mechanism comprises an annular element, integral with the control lever, positioned about the retention means and having a cam profile configured to be rotatable by the control lever between a pin locking position, in which the annular element radially acts on the retention means to bring and retain the retention means in the advanced pin locking position, and a pin releasing position, in which the annular element allows radial retraction of the retention means to the retracted pin releasing position.

3. The spacer of claim 1, wherein the retention means comprise at least a pair of balls, and wherein an annular groove suitable for being engaged by the balls is provided in the anchoring pin.

4. The spacer of claim 3, wherein the pin seat is delimited by a side wall in which radial through openings are formed, in each of which a respective ball is partially accommodated, the respective ball being radially translatable between a retracted position and an advanced position.

5. The spacer of claim 3, wherein the annular element forms, for each ball, a first concave portion and a second concave portion, the first concave portion having a smaller concavity than the second concave portion so as to define an advanced position and a retracted position of the respective ball, respectively.

6. The spacer of claim 5, wherein the first and second concave portions are circumferentially separated by a collapsible intermediate portion.

7. The spacer of claim 1, wherein the fastening plate comprises a guide portion configured to receive the proximal portion of the spacer rod with shape coupling, so as to prevent a rotation of the spacer rod about the pin axis.

8. The spacer of claim 1, wherein a distal portion of the spacer rod supports a bag connecting plate, comprising bag anchoring means.

9. The spacer of claim 8, wherein said bag anchoring means comprise belt anchoring zones.

10. The spacer of claim 8, wherein said bag anchoring means comprise magnetic coupling elements.
